(19) United States
(12) Patent Application Publication
(10) Pub. No.: US 2010/0110508 A1
(43) Pub. Date: May 6, 2010

(54) PRINTING APPARATUS HAVING COMMON SCANNING AND PRINTING FEED PATH

(75) Inventor: Richard CAMPBELL, Rochester, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 12/262,471

(22) Filed: Oct. 31, 2008

(51) Int. Cl. H04N 1/04

(52) U.S. Cl. 358/498

(57) ABSTRACT

Disclosed are an apparatus including a media feed tray holding media to be printed, a media printing feed path along which the media to be printed are fed from the media feed tray, a scanner feed tray holding media to be scanned, and a scanner feed path along which the media to be scanned are fed from the scanner feed tray, wherein the scanner feed path overlaps with at least a portion of the media printing feed path, and a corresponding method.

### BACKGROUND

Disclosed are printing apparatus having a common scanning and printing feed path.

In a typical printing apparatus, media such as paper will be stored in a tray or trays. When printing occurs, typically the paper will be pulled from the tray and fed through a printing feed path. Typically the paper will be driven through the printing feed path by rollers such as drive rollers. Where the printer is an electrophotographic printer, the rollers will drive the paper along the printing feed path to printing elements such as a photoreceptor, fuser, and the like. Where the printer is an ink jet printer, the drive rollers will drive the paper along the printing feed path to printing elements such as an inkjet printhead, a print assembly, a pressure roll, and the like.

Some typical printing apparatus will also include a scanning function. A typical printing apparatus with such scanning function may include a document handler for inputting pages. Such document handler typically has an input tray for inputting a media sheet, and has a scanning feed path through which the media sheet is fed past a scanning device, such as a full width scanning array, and typically to an output tray.

These printing apparatus with scanning and printing functionality thus typically include two separate subassemblies, one including the printing feed path and associated elements, and another including the scanning feed path and associated elements. The use of two such subassemblies and associated elements requires extra space and makes the printing/scanning device large.

### SUMMARY

According to aspects of the embodiments, there is provided an apparatus including a media feed tray holding media to be printed, a media printing feed path along which the media to be printed are fed from the media feed tray, a scanner feed tray holding media to be scanned, and a scanner feed path along which the media to be scanned are fed from the scanner feed tray, wherein the scanner feed path overlaps with at least a portion of the media printing feed path, and a corresponding method.

### BRIEF DESCRIPTION OF THE DRAWINGS

FIG. 1 illustrates a schematic view of an electrophotographic apparatus.

FIG. 2 illustrates a diagram of a printing apparatus.

FIG. 3 illustrates a diagram of a printing apparatus.

### DETAILED DESCRIPTION

While the present invention will be described in connection with preferred embodiments thereof, it will be understood that it is not intended to limit the invention to that embodiment. On the contrary, it is intended to cover all alternatives, modifications and equivalents as may be included within the spirit and scope of the invention as defined by the appended claims.

The embodiments include a printing apparatus, including a media feed tray holding media to be printed, a media printing feed path along which the media to be printed are fed from the media feed tray, a scanner feed tray holding media to be scanned, and a scanner feed path along which the media to be scanned are fed from the scanner feed tray, wherein the scanner feed path overlaps with at least a portion of the media printing feed path.

The embodiments further include an image production apparatus, that includes a printing feed path along which media to be printed is fed, the printing feed path for directing the media to be printed to a scanning device, a photoreceptor and a fuser, and a scanning feed path along which media to be scanned is fed, the scanning feed path overlapping with a portion of the media feed path, the scanning feed path for directing media to be scanned to the scanning device.

The embodiments further include a method of controlling operations in a printing apparatus. The method includes directing media to be printed from a media feed tray along a printing feed path, directing media to be scanned along a scanner feed path to a scanning device, wherein the scanner feed path overlaps with at least a portion of the printing feed path.

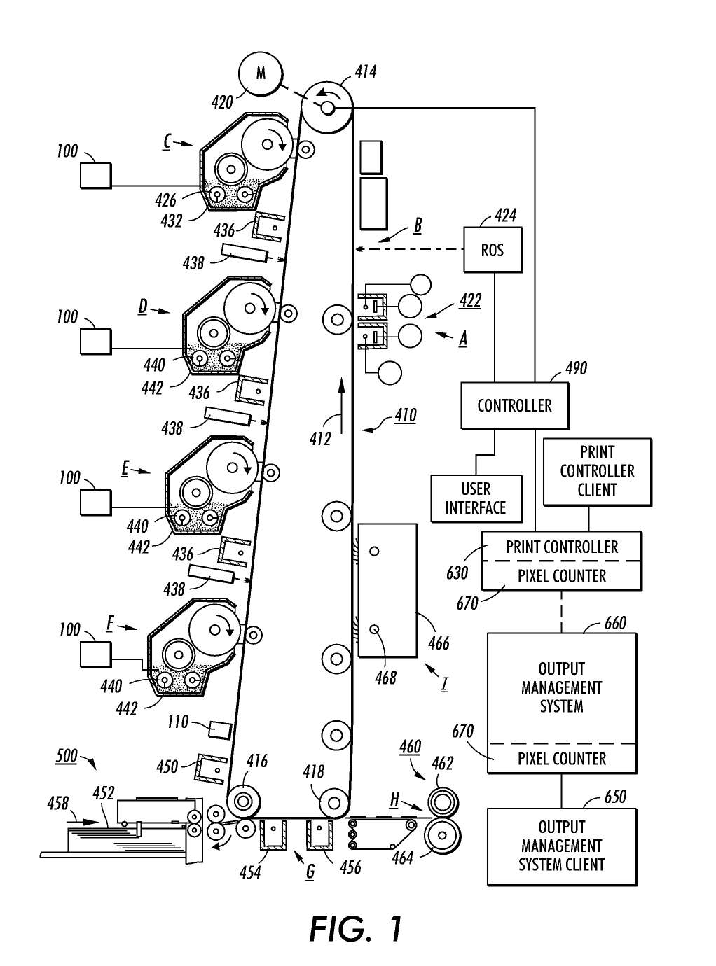

In as much as the art of electrophotographic printing is well known, the various processing stations employed in the FIG. 1 printing machine will be shown schematically and their operation described briefly with reference thereto. Various other printing machines could also be used including an inkjet or other type of printer, and this is only an example of a particular printing machine that may be used with the invention.

FIG. 1 is a partial schematic view of a digital imaging system, such as the digital imaging system of U.S. Pat. No. 6,505,832, which is hereby incorporated by reference. The imaging system is used to produce an image such as a color image output in a single pass of a photoreceptor belt. It will be understood, however, that it is not intended to limit the invention to the embodiment disclosed. On the contrary, it is intended to cover all alternatives, modifications and equivalents as may be included within the spirit and scope of the invention as defined by the appended claims, including a multiple pass color process system, a single or multiple pass highlight color system, and a black and white printing system.

Referring to FIG. 1, an Output Management System 660 may supply printing jobs to the Print Controller 630. Printing jobs may be submitted from the Output Management System Client 650 to the Output Management System 660. A pixel counter 670 is incorporated into the Output Management System 660 to count the number of pixels to be imaged with toner on each sheet or page of the job, for each color. The pixel count information is stored in the Output Management System memory. The Output Management System 660 submits job control information, including the pixel count data, and the printing job to the Print Controller 630. Job control information, including the pixel count data, and digital image data are communicated from the Print Controller 630 to the Controller 490.

The printing system preferably uses a charge retentive surface in the form of an Active Matrix (AMAT) photoreceptor belt 410 supported for movement in the direction indicated by arrow 412, for advancing sequentially through the various xerographic process stations. The belt is entrained about a drive roller 414, tension roller 416 and fixed roller 418 and the drive roller 414 is operatively connected to a drive motor 420 for effecting movement of the belt through the xerographic stations. A portion of photoreceptor belt 410 passes through charging station A where a corona generating device, indicated generally by the reference numeral 422, charges the photoconductive surface of photoreceptor belt 410 to a relatively high, substantially uniform, preferably negative potential.

Next, the charged portion of photoconductive surface is advanced through an imaging/exposure station B. At imaging/exposure station B, a controller, indicated generally by reference numeral 490, receives the image signals from Print Controller 630 representing the desired output image and processes these signals to convert them to signals transmitted to a laser based output scanning device, which causes the charge retentive surface to be discharged in accordance with the output from the scanning device. Preferably the scanning device is a laser Raster Output Scanner (ROS) 424. Alternatively, the ROS 424 could be replaced by other xerographic exposure devices such as LED arrays.

The photoreceptor belt 410, which is initially charged to a voltage V0, undergoes dark decay to a level equal to about −500 volts. When exposed at the exposure station B, it is discharged to a level equal to about −50 volts. Thus after exposure, the photoreceptor belt 410 contains a monopolar voltage profile of high and low voltages, the former corresponding to charged areas and the latter corresponding to discharged or developed areas.

At a first development station C, developer structure, indicated generally by the reference numeral 432 utilizing a hybrid development system, the developer roller, better known as the donor roller, is powered by two developer fields (potentials across an air gap). The first field is the AC field which is used for toner cloud generation. The second field is the DC developer field which is used to control the amount of developed toner mass on the photoreceptor belt 410. The toner cloud causes charged toner particles to be attracted to the electrostatic latent image. Appropriate developer biasing is accomplished via a power supply. This type of system is a noncontact type in which only toner particles (black, for example) are attracted to the latent image and there is no mechanical contact between the photoreceptor belt 410 and a toner delivery device to disturb a previously developed, but unfixed, image. A toner concentration sensor 200 senses the toner concentration in the developer structure 432.

The developed but unfixed image is then transported past a second charging device 436 where the photoreceptor belt 410 and previously developed toner image areas are recharged to a predetermined level.

A second exposure/imaging is performed by device 438 which comprises a laser based output structure which is utilized for selectively discharging the photoreceptor belt 410 on toned areas and/or bare areas, pursuant to the image to be developed with the second color toner. At this point, the photoreceptor belt 410 contains toned and untoned areas at relatively high voltage levels, and toned and untoned areas at relatively low voltage levels. These low voltage areas represent image areas which are developed using discharged area development (DAD). To this end, a negatively charged, developer material 440 comprising color toner is employed. The toner, which by way of example may be yellow, is contained in a developer housing structure 442 disposed at a second developer station D and is presented to the latent images on the photoreceptor belt 410 by way of a second developer system. A power supply (not shown) serves to electrically bias the developer structure to a level effective to develop the discharged image areas with negatively charged yellow toner particles. Further, a toner concentration sensor 200 senses the toner concentration in the developer housing structure 442.

The above procedure is repeated for a third image for a third suitable color toner such as magenta (station E) and for a fourth image and suitable color toner such as cyan (station F). The exposure control scheme described below may be utilized for these subsequent imaging steps. In this manner a full color composite toner image is developed on the photoreceptor belt 410. In addition, a mass sensor 110 measures developed mass per unit area. Although only one mass sensor 110 is shown in FIG. 1, there may be more than one mass sensor 110.

To the extent to which some toner charge is totally neutralized, or the polarity reversed, thereby causing the composite image developed on the photoreceptor belt 410 to consist of both positive and negative toner, a negative pre-transfer dicorotron member 450 is provided to condition the toner for effective transfer to a substrate using positive corona discharge.

Subsequent to image development a sheet of support material 452 is moved into contact with the toner images at transfer station G. The sheet of support material 452 is advanced to transfer station G by a sheet feeding apparatus 500, described in detail below. The sheet of support material 452 is then brought into contact with photoconductive surface of photoreceptor belt 410 in a timed sequence so that the toner powder image developed thereon contacts the advancing sheet of support material 452 at transfer station G.

Transfer station G includes a transfer dicorotron 454 which sprays positive ions onto the backside of sheet 452. This attracts the negatively charged toner powder images from the photoreceptor belt 410 to sheet 452. A detack dicorotron 456 is provided for facilitating stripping of the sheets from the photoreceptor belt 410.

After transfer, the sheet of support material 452 continues to move, in the direction of arrow 458, onto a conveyor 600 which advances the sheet to fusing station H. Fusing station H includes a fuser assembly, indicated generally by the reference numeral 460, which permanently affixes the transferred powder image to sheet 452. Preferably, fuser assembly 460 comprises a heated fuser roller 462 and a backup or pressure roller 464. Sheet 452 passes between fuser roller 462 and pressure roller 464 with the toner powder image contacting fuser roller 462. In this manner, the toner powder images are permanently affixed to sheet 452. After fusing, a chute, not shown, guides the advancing sheet 452 to a catch tray, stacker, finisher or other output device (not shown), for subsequent removal from the printing machine by the operator. The fuser assembly 460 may be contained within a cassette, and may include additional elements not shown in this figure, such as an endless fuser belt or endless fuser web (not the fuser cleaner web) around the fuser roller 462. In typical printing machines, this belt or web has been kept relatively short to minimize the size of the fuser assembly or cassette.

After the sheet of support material 452 is separated from photoconductive surface of photoreceptor belt 410, the residual toner particles carried by the non-image areas on the photoconductive surface are removed therefrom. These particles are removed at cleaning station I using a cleaning brush or plural brush structure contained in a housing 466. The cleaning brushes 468 are engaged after the composite toner image is transferred to a sheet.

Controller 490 regulates the various printer functions. The controller 490 is preferably a programmable controller, which controls printer functions hereinbefore described. The controller 490 may provide a comparison count of the copy sheets, the number of documents being recirculated, the number of copy sheets selected by the operator, time delays, jam corrections, etc. The control of all of the exemplary systems heretofore described may be accomplished by conventional control switch inputs from the printing machine consoles selected by an operator. Conventional sheet path sensors or switches may be utilized to keep track of the position of the document and the copy sheets.

The foregoing description illustrates the general operation of an electrophotographic printing machine incorporating the fuser apparatus of the present disclosure therein. Not all of the elements discussed in conjunction with FIG. 1 are necessarily needed for effective use of the invention. Instead, these elements are described as a machine within which embodiments of the invention could operate.

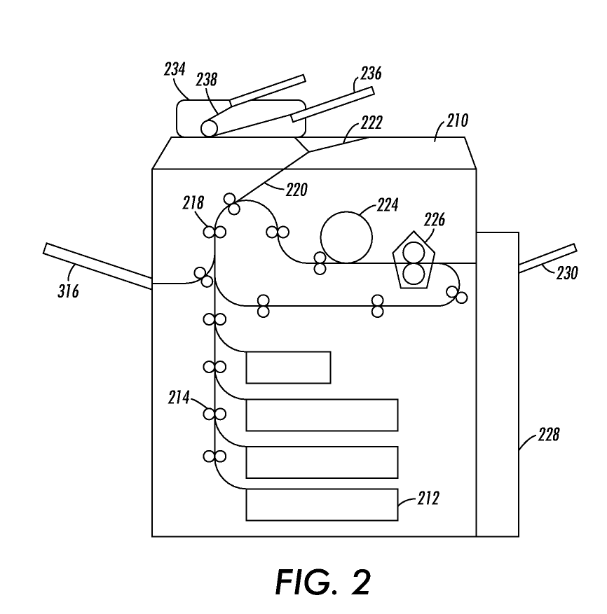

FIG. 2 illustrates a printing apparatus 210, also known as an image production apparatus, which may be an electrophotographic apparatus, in greater detail. The printing apparatus 210 includes media trays 212, which store media such as paper for printing or copying. Any number of media trays 212 may be used. The media may be driven from the media trays 212 along a printing feed path by drive rollers 214, to a photoreceptor 224 and a fuser 226, for example. After printing, the media may exit from the printing apparatus through the assembly 228 and the printing exit tray 230. The printing apparatus 210 may include any of the elements of the FIG. 1 digital imaging system, even though not shown in FIG. 2.

A document handler 234 may be included from which media may traverse a document handler feed path 238 to be output at document handler output tray 236. The document handler 234 may be used for the scanning of media, for example.

The printing apparatus 210 may also include a scanner feed tray 316. The scanner feed tray 316 can feed media to be scanned into the printing apparatus 210, where it may be scanned by scanning device 218, for example. Scanning device 218 may be a duplex scanning device, such as full-width array bars or the like. The scanning device 218 is placed within the same printing feed path as media from the media trays 212. However, media from scanner feed tray 316 does not follow the entire printing feed path, but instead exits from the printing feed path at scanner feed path 220, where it may be directed to the scanner output tray 222, which may be formed as an integral part of a cover of the printing apparatus 210. Thus, media to be scanned from the scanner feed tray 316 does not proceed to the photoreceptor 224 or to the fuser 226.

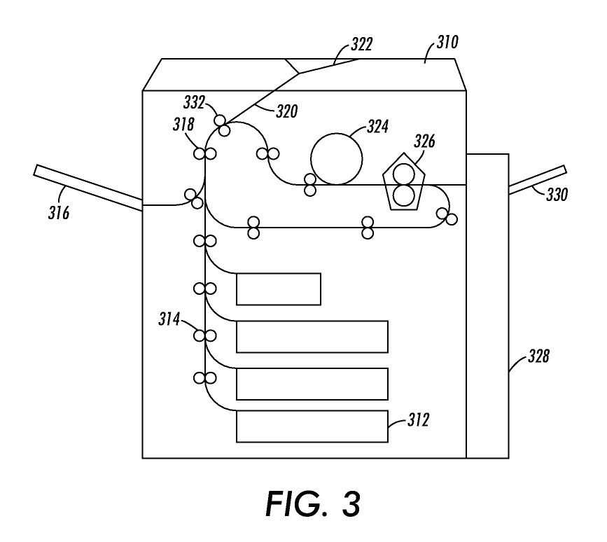

The printing apparatus 310 illustrated in FIG. 3 includes media feed trays 312, from which media may be driven along a printing feed path by drive rollers 314, to a photoreceptor 324 and a fuser 326, for example. After printing, the media may exit from the printing apparatus through the assembly 328 and the printing exit tray 330. The printing apparatus 310 may include any of the elements of FIG. 1 digital imaging system, even though not shown in FIG. 3.

The printing apparatus 310 may also include a scanner feed tray 316. The scanner feed tray 316 can feed media to be scanned into the printing apparatus 310, where it may be scanned by scanning device 318, for example. Scanning device 318 may be a duplex scanning device, such as full-width array bars or the like. The scanning device 318 is placed within the same printing feed path as media from the media trays 312. However, media from scanner feed tray 316 does not follow the entire printing feed path, but, after being diverted by diverter gate 332, exits from the printing feed path and continues in scanner feed path 320, where it may be directed to the scanner output tray 322, which may be formed as an integral part of a cover of the printing apparatus 310.

In the embodiment of FIG. 3, the document handler 234 has been eliminated. All scanning functions can be accomplished with the scanner feed tray 316 and the scanning device 318. Typical printing apparatus that include a scanning function often include such a document handler which can be bulky and increase the cost of production. Elimination of the document handler 234 saves space and eliminates separate feed paths. By sharing the feed path for scanning and printing, space is saved, cost is reduced, and the printing apparatus may be more compact.

The controller 490 of FIG. 1 may have instructions loaded via a computer readable medium. The embodiments may include computer-readable medium for carrying or having computer-executable instructions or data structures stored thereon. Such computer-readable medium can be any available medium that can be accessed by a general purpose or special purpose computer. By way of example, and not limitation, such computer-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hard wired, wireless, or combination thereof to a computer, the computer properly views the connection as a computer-readable medium. Thus, any such connection is properly termed a computer-readable medium. Combinations of the above should also be included within the scope of the computer-readable medium.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein. The instructions for carrying out the functionality of the disclosed embodiments may be stored on such a computer-readable medium.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A printing apparatus, comprising:
a media feed tray holding media to be printed;
a printing feed path along which the media to be printed are fed from the media feed tray;
a scanner feed tray holding media to be scanned; and
a scanner feed path along which the media to be scanned are fed from the scanner feed tray, wherein the scanner feed path overlaps with at least a portion of the printing feed path.

2. The printing apparatus of claim 1, further comprising a scanning device for scanning the media to be scanned, wherein the scanning device is disposed in the media printing feed path and in the scanner feed path.

3. The printing apparatus of claim 1, wherein the scanning device is a duplex scanning device.

4. The printing apparatus of claim 1, wherein the printing feed path directs media to be printed from the media feed tray to the scanning device, to a photoreceptor, to a fuser and to a printing exit tray.

5. The printing apparatus of claim 4, wherein the media to be printed is not scanned by the scanning device when the media to be printed is directed along the printing feed path.

6. The printing apparatus of claim 4, wherein the media to be scanned is directed from the scanner feed tray along the scanner feed path and the printing feed path to the scanning device, and is directed to exit the printing feed path prior to reaching the photoreceptor or the fuser.

7. The printing apparatus of claim 6, further comprising a scanner exit tray where media to be scanned is directed after being scanned by the scanning device.

8. An image production apparatus, comprising:
a printing feed path along which media to be printed is fed, the printing feed path for directing the media to be printed to a scanning device, a photoreceptor and a fuser; and
a scanning feed path along which media to be scanned is fed, the scanning feed path overlapping with a portion of the media feed path, the scanning feed path for directing media to be scanned to the scanning device.

9. The image production apparatus of claim 8, wherein the scanning device is a duplex scanning device.

10. The image production apparatus of claim 8, wherein the media to be printed is not scanned by the scanning device when the media to be printed is directed along the printing feed path.

11. The image production apparatus of claim 8, wherein the media to be scanned is directed along the scanner feed path and the printing feed path to the scanning device, and is directed to exit the printing feed path prior to reaching the photoreceptor or the fuser.

12. The image production apparatus of claim 8, further comprising a scanner exit tray where the media to be scanned is directed after being scanned by the scanning device.

13. A method of controlling operations in a printing apparatus, comprising:
directing media to be printed from a media feed tray along a printing feed path;
directing media to be scanned along a scanner feed path to a scanning device, wherein the scanner feed path overlaps with at least a portion of the printing feed path.

14. The method of claim 13, wherein the scanning device is a duplex scanning device.

15. The method of claim 13, further comprising directing the media to be printed along the printing feed path to the scanning device, to a photoreceptor, to a fuser and to a printing exit tray.

16. The method of claim 15, wherein the media to be printed is not scanned by the scanning device when the media to be printed is directed along the printing feed path.

17. The method of claim 14, further comprising directing the media to be scanned along the scanner feed path and the printing feed path to the scanning device, and to exit the printing feed path prior to reaching the photoreceptor or the fuser.
